(19) United States
(12) Patent Application Publication
(10) Pub. No.: US 2017/0364930 A1
(43) Pub. Date: Dec. 21, 2017

(54) METHOD AND APPARATUS FOR ASSESSING CUSTOMER VALUE BASED ON CUSTOMER INTERACTIONS WITH ADVERTISEMENTS

(71) Applicant: 24/7 Customer, Inc., Campbell, CA (US)

(72) Inventors: Pallipuram V. KANNAN, Saratoga, CA (US); Kranthi Mitra ADUSUMILLI, Hyderabad (IN)

(21) Appl. No.: 15/624,301

(22) Filed: Jun. 15, 2017

(30) Foreign Application Priority Data
Jun. 17, 2016 (IN) 201641020790

(51) Int. Cl. G06Q 30/02

(52) U.S. Cl. CPC G06Q 30/0201; G06Q 30/0249; G06Q 30/0269

(57) ABSTRACT

A computer-implemented method and apparatus for assessing customer value of a customer based on customer interactions with advertisements are disclosed. An initial estimate of a customer value for a customer currently active on a Website related to an enterprise is determined. An estimate of an advertisement spend related to the customer and a propensity of the customer to perform an action in response to an advertisement displayed on the Website is also determined. A revised estimate of the customer value is generated by revising the initial estimate of customer value based on the estimate of advertisement spend related to the customer and the propensity of the customer to perform the action. The revised estimate of customer value is used to facilitate engagement with the customer on the Website.

### CROSS REFERENCE TO RELATED APPLICATIONS

This application claims priority to Indian provisional patent application serial no. 201641020790, filed Jun. 17, 2016, which application is incorporated herein in its entirety by this reference thereto.

### TECHNICAL FIELD

The invention generally relates to customer value assessment mechanisms and, more particularly, to a method and apparatus for assessing customer value based on customer interactions with advertisements.

### BACKGROUND

Assessing value of a customer relationship, or in general of a customer, may be performed using various known techniques. For example, Customer Lifetime Value or CLV is a well-known concept used in a number of fields for representing a monetary value of a customer relationship or, more specifically, CLV is a prediction of all value a business derives from their its relationship with a customer.

Enterprises typically use such customer value assessment mechanisms to identify a right segment of customers to treat differentially to maximize their revenue, to design appropriate advertisement campaigns, to model chum rates of the customers, and the like.

Conventional approaches generally model customer value as a function of monetary values associated with past transactions, frequency of transactions, recency of transactions, and the like. Such approaches of assessing customer value do not take into account a cost component associated with marketing a product or a service to a customer. For example, sizable cost is incurred in displaying advertisements to the customers. It would be advantageous to take into account the revenue spent on a customer by an enterprise for more accurately assessing a customer value and, thereby effectively manage the customer relationship.

### SUMMARY

In an embodiment of the invention, a computer-implemented method for assessing customer value based on customer interactions with advertisements is disclosed. The method determines, by a processor, an initial estimate of a customer value for a customer of an enterprise. The customer is currently active on a Website related to the enterprise. The method determines, by the processor, at least one of an estimate of an advertisement spend related to the customer and a propensity of the customer to perform an action in response to an advertisement displayed on the Website. The method generates, by the processor, a revised estimate of the customer value by revising the initial estimate of the customer value based on at least one of the estimate of advertisement spend related to the customer and the propensity of the customer to perform the action in response to an advertisement displayed on the Website. The method facilitates, by the processor, engagement with the customer on the Website. A type of engagement with the customer is determined based on the revised estimate of the customer value.

In another embodiment of the invention, an apparatus configured to assess customer value based on customer interactions with advertisements is disclosed. The apparatus includes at least one processor and a memory. The memory has stored therein machine executable instructions, that when executed by the at least one processor, cause the apparatus to determine an initial estimate of a customer value for a customer of an enterprise. The customer is currently active on a Website related to the enterprise. The apparatus determines at least one of an estimate of an advertisement spend related to the customer and a propensity of the customer to perform an action in response to an advertisement displayed on the Website. The apparatus generates a revised estimate of the customer value by revising the initial estimate of the customer value based on at least one of the estimate of advertisement spend related to the customer and the propensity of the customer to perform the action in response to the advertisement displayed on the Website. The apparatus facilitates engagement with the customer on the Website. A type of engagement with the customer is determined based on the revised estimate of the customer value.

In an embodiment of the invention, a computer-implemented method for assessing customer value based on customer interactions with advertisements is disclosed. The method determines, by a processor, an initial estimate of a customer lifetime value (CLV) for a customer of an enterprise. The customer is currently active on a Website related to the enterprise. The method determines, by the processor, an estimate of advertisement spend by computing an aggregate cost of advertisements displayed to the customer over a predefined time period. The method determines, by the processor, a propensity of the customer to perform an action in response to an advertisement displayed on the Website. The method generates, by the processor, a revised estimate of the CLV based on a cumulative effect of depreciation in the CLV caused by increasing advertising revenue spend and an appreciation in the CLV caused by potential impact of the advertisement displayed on the Website. The advertising revenue spend is computed based on the estimate of the advertisement spend and a cost associated with the advertisement. The potential impact of the advertisement is determined based on the propensity of the customer to perform an action in response to the advertisement. The method generates, by the processor, one or more recommendations corresponding to the customer based on the revised estimate of the CLV. The method provisions, by the processor, at least one of preferential treatment and personalized treatment to the customer based on the one or more recommendations.

### BRIEF DESCRIPTION OF THE FIGURES

FIG. 1 is a representation showing a customer browsing a Website of an enterprise in accordance with an embodiment of the invention;

FIG. 2 is a block diagram of a system configured to assess customer values of customers based on respective customer interactions with advertisements in accordance with an embodiment of the invention;

FIG. 3 shows an example advertisement displayed to a customer in accordance with an embodiment of the invention;

FIG. 4 shows a representation for illustrating assessment of customer value based on customer interactions with advertisements in accordance with an embodiment of the invention;

FIG. 5 is a flow diagram of an example method for assessing customer value of a customer based on customer interactions with advertisements in accordance with an embodiment of the invention; and

FIG. 6 is a flow diagram of an example method for assessing customer value of a customer based on customer interactions with advertisements in accordance with another embodiment of the invention.

### DETAILED DESCRIPTION

The detailed description provided below in connection with the appended drawings is intended as a description of various embodiment of the invention and is not intended to represent the only forms in which the invention may be constructed or used. However, the same or equivalent functions and sequences may be accomplished by different embodiments of the invention.

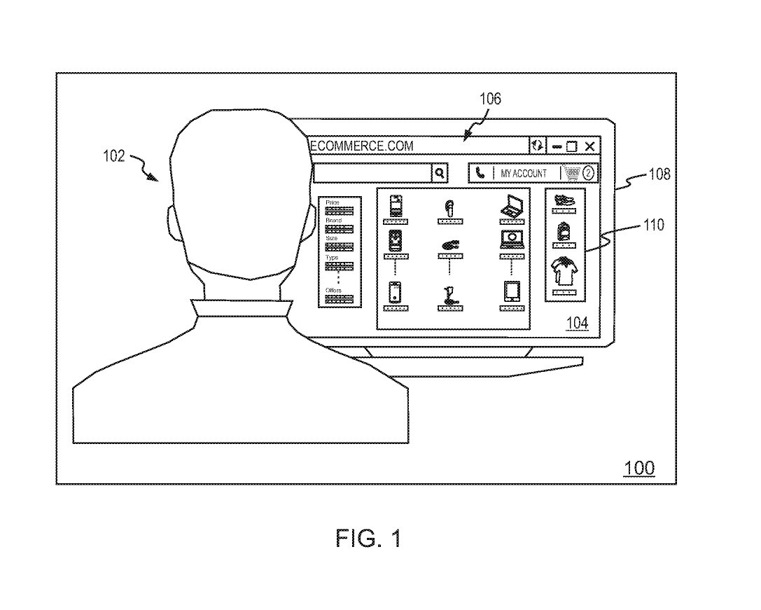

FIG. 1 is a representation 100 showing a customer 102 browsing a Website 104 of an enterprise in accordance with an embodiment of the invention. The customer 102 is depicted to have accessed the Website 104 using a Web browser application 106 installed on a desktop computer 108. In the representation 100, the Website 104 is exemplarily depicted as an E-commerce Website. However, the enterprise Website may not be limited to an E-commerce Website. In some embodiments, the Website 104 may correspond to any one of a social networking Website, an educational content related portal, a news aggregator portal, a gaming or sports content related Website, a Web search engine service providing Website, a banking Website, or any such Website related to a corporate or governmental entity. The Website 104 may be hosted on a remote Web server associated with the enterprise, and the Web browser application 106 may be configured to retrieve one or more Web pages associated with the Website 104 over a communication network. Examples of the communication network may include wired networks, wireless networks, and combinations thereof. Some examples of wired networks may include the Ethernet, local area networks (LANs), fiber-optic cable networks, and the like. Some examples of wireless networks may include cellular networks, such as GSM/3G/4G/CDMA networks, wireless LANs, blue-tooth or Zigbee networks, and the like. An example of a combination of wired and wireless networks may include the Internet. The Website 104 may attract a large number of existing and/or potential customers, such as the customer 102. Moreover, the customers may use Web browser applications installed on a variety of electronic devices, such as mobile phones, smartphones, tablet computers, laptops, Web enabled wearable devices such as smart watches, and the like to access the Website 104 over the communication network.

Most enterprises typically seek to estimate customer value of their customers, such as the customer 102. The customer value may be calculated at an individual level and/or at a segment level. In some embodiments, the customer value is used for identifying a right segment of customers to treat differentially to maximize their revenue, to design appropriate advertisement campaigns, to model churn rates of customers, and the like. The right segment of customers is provided with differential treatment, for example, the customers are preferentially routed to suitable agents or frequently provided with promotional offers or discounts, and the like. For example, if the customer 102 has a high customer value, then the enterprise may display widgets or pop-up windows offering promotional offers or discounts to the customer 102 for a product that the customer is currently viewing on the Website 104. In another example, the customer 102 may be offered agent assistance through chat or voice channel to enable the customer 102 to make a purchase or to improve an online experience of the customer 102.

Conventional mechanisms for estimating customer value are based on projected incremental revenue from retentions or acquisitions of customers for a given marketing spend on the customers. The customer value may be estimated using any one of several models, such as those based on Recency-Frequency-Monetary value (or RFM) approach, stochastic modeling, Markov models, Markov decision process (MDP), policy iteration algorithms for infinite horizon problems, value iteration algorithms for finite horizon problems, survival models, retention or churn models, and the like. Such approaches model customer value as a function of recency, frequency, monetary value, discount rate, churn/retention rate, and the like. For example, the RFM approach may analyze customer behavior based on how recently the customer 102 interacted with the Website 104 or performed a transaction on the Website 104, the frequency of such interactions, and the monetary value associated with those transactions.

However, such approaches do not take into account a cost component associated with marketing a product or a service to a customer. For example, sizable cost is incurred in displaying advertisements, such as an advertisement 110 displayed on the Website 104, to the customers. Precluding the marketing cost (for example, advertisement spend) while estimating the customer value may result in the customer value not reflecting an actual value to be accrued from the relationship with the customer. In an illustrative example, a customer who is known to make a purchase only after viewing an advertisement several times should have a lower customer value than a customer who is an impulsive buyer and who is likely to purchase an enterprise offering upon seeing the advertisement for the first time because the overall marketing spend would have increased for the known customer. Further, in some embodiments a cost of product/service being evaluated for purchase (for example, a high value product or a low value product), and a likelihood of conversion of the customer from a prospective customer to a buyer upon being progressively shown several advertisements, also needs to be taken into account while estimating the customer value. The current customer value estimation measures do not take such factors into consideration and, as such, the customer value estimation mechanisms need improvement.

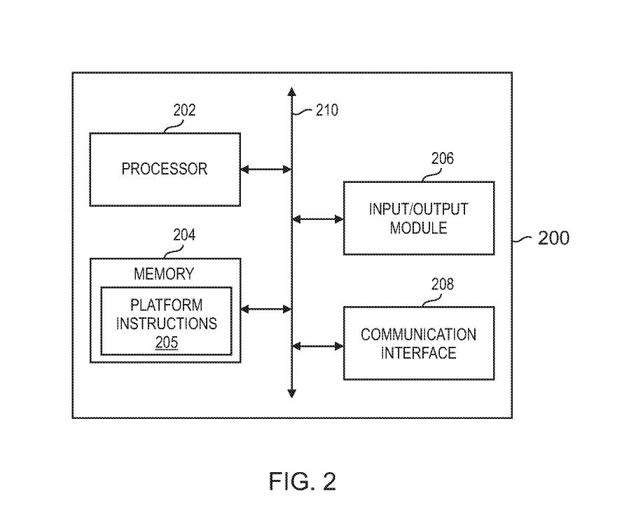

Various embodiments of the invention provide a method and apparatus for assessing customer value that are capable of overcoming these and other obstacles and providing additional benefits. More specifically, the method and apparatus disclosed herein take advertisement spend corresponding to the customer and a propensity of the customer to convert from a prospective customer to a buyer into account to estimate customer value of the customer. An apparatus for assessing customer values of customers based on respective customer interactions with advertisements is explained with reference to FIG. 2.

FIG. 2 is a block diagram of an apparatus 200 configured to assess customer values of customers based on respective customer interactions with advertisements in accordance with an embodiment of the invention. The apparatus 200 is configured to take into account aggregate cost of advertisements displayed to the customer and a propensity of the customer to perform an action (such as a purchase transaction, for instance) if an advertisement is displayed to the customer on a Website to estimate customer value of the customer.

In an embodiment, the apparatus 200 is embodied as an interaction platform with one or more components of the apparatus 200 implemented as a set of software layers on top of existing hardware systems. The interaction platform may be communicably coupled over a communication network with one or more interaction channels associated with the enterprise, such as an enterprise Web channel (i.e. an enterprise Website), an interactive voice response (IVR) channel, a chat channel (i.e. a channel offering agent-based chat support to customers), a voice channel (i.e. channel offering agent-based voice support to customers), a social media channel, a native mobile application channel, and the like. In some embodiments, the interaction platform may also be communicably associated with personal devices of the customers of the one or more enterprises and configured to receive information related to customer-enterprise interactions from the personal devices of the customers.

The apparatus 200 includes at least one processor, such as a processor 202 and a memory 204. Although the apparatus 200 is depicted to include only one processor, the apparatus 200 may include more number of processors therein. In an embodiment, the memory 204 is capable of storing machine executable instructions, referred to herein as platform instructions 205. Further, the processor 202 is capable of executing the platform instructions 205. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory)), etc.

The apparatus 200 also includes an input/output module 206 (hereinafter referred to as ‘I/O module 206’) and at least one communication interface such as the communication interface 208. In an embodiment, the I/O module 206 may include mechanisms configured to receive inputs from and provide outputs to the user of the apparatus 200. To that effect, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication interface 208 may include several channel interfaces to receive information from one or more interaction channels related to an enterprise. The one or more interaction channels may correspond to on-domain or off-domain interaction channels. It is noted that for an enterprise for which the ads are to be provisioned to the customers, the interaction channels associated with the enterprise are referred to herein as ‘on-domain’ enterprise interaction channels. Some non-exhaustive examples of such interaction channels may include a Web channel (i.e. an enterprise Website), a voice channel (i.e. voice-based customer support offered by the enterprise), a chat channel (i.e. a chat support offered by the enterprise), a native mobile application channel, and the like. For example, if an advertisement (also interchangeably referred to hereinafter as ‘ad’) of an enterprise ABC is displayed on a Website ‘www.enterprise-abc.com’ associated with the enterprise ABC, then the Website corresponds to an on-domain enterprise interaction channel, and the ad corresponds to an on-domain advertisement.

Similarly, for an enterprise for which the ads are to be provisioned to the customers, the interaction channels not associated with the enterprise are referred to herein as ‘off-domain’ enterprise interaction channels. For example, if an ad of a telecom-enterprise XYZ is displayed on an e-commerce Website ‘www.ecommerce-enterprise.com’, then the Website corresponds to an off-domain enterprise interaction channel and the ad corresponds to an off-domain advertisement. All interaction channels used for displaying advertisements, whether off-domain or on-domain channels, are referred to herein as interaction channels related to the enterprise.

As explained above, the communication interface 208 may include several channel interfaces to receive information from a plurality of on-domain and off-domain interaction channels. Each interaction channel interface of the communication interface 208 may be associated with a respective communication circuitry such as, for example, a transceiver circuitry including antenna and other communication media interfaces to connect to a wired and/or wireless communication network. The communication circuitry associated with each channel interface may, in at least some example embodiments, enable transmission of data signals and/or reception of signals from remote network entities, such as Web servers hosting enterprise and non-enterprise Websites, advertisement servers configured to display advertisements on Websites, servers associated with advertisement platforms configured to facilitate bidding between enterprises for placement of advertisements, cloud-based platforms, or servers deployed at enterprise customer support and service centers configured to maintain real-time information related to interactions between customers and customer support representatives, and the like.

In at least some embodiments, the communication interface 208 may include relevant Application Programming Interfaces (APIs) to communicate with various customer touch points, such as electronic devices associated with the customers, Websites visited by the customers, devices used by customer support representatives (for example, voice agents, chat agents, IVR systems, in-store agents, and the like) engaged by the customers, and the like.

In an embodiment, various components of the system 200, such as the processor 202, the memory 204, the I/O module 206, and the communication interface 208 are configured to communicate with each other via or through a centralized circuit system 210. The centralized circuit system 210 may be various devices configured to, among other things, provide or enable communication between the components (202-208) of the apparatus 200. In certain embodiments, the centralized circuit system 210 may be a central printed circuit board (PCB), such as a motherboard, a main board, a system board, or a logic board. The centralized circuit system 210 may also, or alternatively, include other printed circuit assemblies (PCAs) or communication channel media. In some embodiments, the centralized circuit system 210 may include appropriate storage interfaces to facilitate communication between the processor 202 and the memory 204. Some examples of the storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to the data stored in the memory 204.

The apparatus 200 as illustrated and hereinafter described is merely illustrative of an apparatus that could benefit from embodiments of the invention and, therefore, should not be taken to limit the scope of the invention. The apparatus 200 may include fewer or more components than those depicted in FIG. 2. In an embodiment, one or more components of the apparatus 200 may be deployed in a Web server. In another embodiment, the apparatus 200 may be a standalone component in a remote machine connected to a communication network and capable of executing a set of instructions (sequential and/or otherwise) to facilitate assessment of customer values of customers based on respective customer interactions with advertisements. Moreover, the apparatus 200 may be implemented as a centralized system, or, alternatively, the various components of the apparatus 200 may be deployed in a distributed manner while being operatively coupled to each other. In an embodiment, one or more functionalities of the apparatus 200 may also be embodied as a client within devices, such as customers' devices. In another embodiment, the apparatus 200 may be a central system that is shared by or accessible to each of such devices.

The assessment of customer value based on customer interactions with advertisements by the apparatus 200 is explained hereinafter with reference to one customer. The apparatus 200 is configured to assess customer values for several other customers of the enterprise in a similar manner. The term ‘assessing customer value’ as used herein implies evaluating customer value and, if needed, adjusting or correcting the estimate of customer value to improve accuracy thereof.

In at least one example embodiment, the processor 202 is configured to, with the content of the memory 204, cause the apparatus 200 to determine an initial estimate of a customer value for a customer currently active on a Website related to the enterprise. The term ‘customer value’ as used herein refers to a value a business derives from their relationship with a customer over a predefined period of time. If the predefined period of time is considered to be a customer's lifetime, or more specifically, if the entire relationship with a customer is taken into account, then such a predicted customer value may represent a customer lifetime value.

In one embodiment, the initial estimate of the customer value is determined using interaction data associated with past interactions of the customer with the enterprise on one or more interaction channels. As explained above, the communication interface 208 may be in operative communication with several interaction channels and may receive information related to interaction data for each customer of the enterprise. In an embodiment, activity of a customer on an interaction channel may be tracked and captured. For example, information captured corresponding to an activity of a customer on a Website of an enterprise may include information such as Web pages visited, time spent on each Web page, menu options accessed, drop-down options selected or clicked, mouse movements, hypertext mark-up language (HTML) links those which are clicked and those which are not clicked, focus events (for example, events during which the customer has focused on a link/Webpage for a more than a pre-determined amount of time), non-focus events (for example, choices the customer did not make from information presented to the customer (for examples, products not selected) or non-viewed content derived from scroll history of the visitor), touch events (for example, events involving a touch gesture on a touch-sensitive device such as a tablet), non-touch events, and the like.

An enterprise may use tags, such as HTML tags or JavaScript tags on the various elements of the Website or, alternatively, the enterprise may open up a socket connection to capture information related to customer activity on a Website. Further, one or more interfaces of the communication interface 208 may be communicably associated with Web servers hosting Web pages of the enterprise Website to receive such information.

The communication interface 208 may be configured to receive information related to tracked activity of a plurality of customers on the various interaction channels and store information related to the activity of the customers in a database (not shown) in the memory 204. The information related to customer's activity on the Website of the enterprise is considered so far as interaction data, i.e. data related to customer's interaction with the Website. However, the interaction data is not limited to information corresponding to customer's interaction with the Website. In many embodiments, a customer may speak or chat with a customer support representative (also referred to herein as an agent) for seeking assistance. The data related to customer interactions with human/virtual agents of the enterprise is also referred to herein as interaction data. In at least one embodiment, a channel interface of the communication interface 208 may be in operative communication with servers in customer support facilities to receive customer interaction data related to customer interactions with the agents of the enterprise.

The interaction data corresponding to each customer may be used to determine an initial estimate of customer value for respective customer. Several models may be used for estimating the initial estimate of customer value of the customer. In some embodiments, a monetary value may be assigned to the customer as the initial estimate of customer value. The monetary value may be based on previous products purchased and a cumulative monetary value associated with all previous interactions across various channels. For example, the monetary value of a customer may be estimated based on cumulative revenue or margin from all historic purchases, as well as aggregated weighted monetary value of all products viewed by the customer, clicked by the customer, hovered over by customer, touched by the customer, and the like.

In one embodiment, the processor 202 may be configured to compute a customer lifetime value (CLV) estimate for the customer using the interaction data. The computed CLV estimate may serve as the initial estimate of the customer value for the customer. In an embodiment, the memory 204 may be configured to store at least one algorithm for computing the CLV estimate using recency-frequency-monetary value (RFM) approach which models the customer value as a function of how recently the customer interacted with the enterprise, a frequency of customer interactions, and monetary values of customer transactions associated with the customer interactions. The components related to the recency and frequency of interactions in the RFM approach, or any other model/approach used for computing the CLV estimate, may take into account customer interactions across one or more of a plurality of interaction channels. For example, a customer may have contacted an enterprise five times over a chat channel and three times over a voice channel in the past week. In such a scenario, frequency of contacts for the customer is computed across the chat channel and the voice channel or any other channel through which the customer may have interacted in the past week. Accordingly, the CLV estimate for such a customer is higher when compared with another customer's CLV estimate who has contacted only once over a social channel and twice over the chat channel in the same week, assuming that other parameters for the two customers are alike.

In an example embodiment, a monetary value may be determined corresponding to each interaction channel that the customer has used for interacting with the enterprise and the CLV estimate may be computed by averaging or weighted averaging of the monetary values corresponding to the various interaction channels. For example, a monetary value corresponding to the Web channel may be determined based on cumulative revenue or margin from all historic purchases, as well as aggregated weighted monetary value of all products viewed by the customer, clicked by the customer, hovered over by the customer, touched by the customer, and the like. The monetary value may also be derived or adjusted from parameters, such as the time spent on a view, time spent on pages, time spent on site, etc. In another illustrative example, on a chat channel monetary value may be extracted based on identifying the products mentioned in a chat conversation through named entity recognition, or collaboratively tagged by users on the chat or voice platform. An overall monetary value across various interaction channels for each customer may then be determined by the apparatus 200 using suitable classifiers, models, or collaborative tags to arrive at the CLV estimate. In an illustrative example, the CLV estimate for a customer may be 950 US dollars based on the RFM approach. For another customer with different variables related to recency of interactions, frequency of interactions, and monetary values associated with those interactions the CLV estimate may be different such as, for example, 800 US dollars. Such CLV estimates enable the enterprise to segment the customers into different categories and cater to them based on their perceived customer values.

The customer value may be estimated in other forms and may not be limited to a CLV estimate. Moreover, the CLV estimate may be determined using any one of several models, such as those based on stochastic modeling, Markov models, Markov decision process (MDP), policy iteration algorithms for infinite horizon problems, value iteration algorithms for finite horizon problems, survival models, retention or churn models, and the like and may not be limited to the RFM approach. Such approaches model CLV as a function of recency, frequency, monetary value, discount rate, churn/retention rate, acquisition rate, retention costs, acquisition costs, revenue, advertising or campaign cost, cost of serving the customers, state transition probability matrix, and the like.

In some embodiments, the customer may be a first-time visitor to an enterprise Website and may not have sufficient interaction data to facilitate determination of the initial estimate of customer value using modeling approaches suggested above. In such embodiments, the apparatus 200 identifies a customer segment relevant to the customer from among a plurality of customer segments. For example, based on the geographical location, type of browser/operating system associated with the customer, information from current Web journey (i.e. products viewed, selected etc.) a customer segment may be identified for the customer. Each customer segment may be associated with a customer value. More specifically, the processor 202 may be configured to classify customers in different segments based on customer values and associate traits or characteristics with each segment. For example, customers in a customer segment may have exhibited a particular Web journey, or used a particular browser or operating system, or belong to a particular geographical location, and the like. For a first-time visitor to an enterprise channel, a customer segment relevant to the customer may be identified from among a plurality of customer segments and the customer value associated with the customer segment may be selected as the initial estimate of the customer value for the customer.

In at least one example embodiment, the processor 202 is configured to, with the content of the memory 204, cause the system 200 to determine an estimate of an advertisement spend related to the customer. In an embodiment, the communication interface 208 may be configured to receive data related to each customer's interaction with digital advertisements of the enterprise displayed to the customer during several past journeys of the customer on the Website, as well as the current journey of the customer on the Website. For example, if a customer was presented an advertisement (associated with ‘x’ cost) during a journey, then the information corresponding to the advertisement presented (such as for example, product information displayed by the advertisement, image content presented, etc.) along with cost related to presenting the advertisement to the customer may be received by the communication interface 208 and stored in the memory 204. In one embodiment, the estimate of the advertisement spend is determined by the processor 202 by computing an aggregate cost of advertisements displayed to the customer over a predefined time period, such as for example ad spend in last 24 hours, in last 7 days, in last 30 days, etc. In an illustrative example, the processor 202 may be configured to track measures, such as the aggregate cost of advertisements displayed to the customer since a last purchase, a number of times a particular advertisement was displayed to the customer, the propensity of the customer to make a purchase when shown the same advertisement (or substantially similar advertisement) multiple number of times, a position of the advertisement of the user interface (UI) on the Web page, and the like.

In an embodiment, the processor 202 is configured to discount the initial estimate of customer value by an amount equivalent to the estimate of advertisement spend related to the customer. For example, if the initial estimate of customer value for a customer, computed using models, such as RFM model, Markov model, etc., or by simply computing a cumulative revenue or margin from all historic purchases, is $850 and, if the estimate of advertisement spend related to the customer since a last purchase is $150, then the customer value may be revised by this amount, i.e. $850−$150, to reflect a customer value of $700.

In at least one example embodiment, the processor 202 is configured to, with the content of the memory 204, cause the system 200 to determine a propensity of the customer to perform an action in response to an advertisement displayed on the Website. More specifically, in some embodiments, a propensity of the customer to initiate a purchase transaction having been displayed a particular advertisement may also be taken into account while correcting the customer value. In some embodiments, the processor 202 may be configured to determine customer preferences from predictive models based on historical interaction data over one or more customer interaction channels, explicit input from customers, customer relationship management (CRM) databases, customer surveys, feedback from customer care representative (tagging by agent), social network analysis, customer review mining, etc. The predictive models may be based on one or more algorithms, such as algorithms based on support vector machines, one versus rest classifiers, decision trees, random forests, Naïve Bayes, logistic regression, clustering (Kmeans or hierarchical clustering), text classification on customer reviews, social mining, speech or voice classification, image recognition algorithms on facial gestures or postures, body movements, handwriting recognition algorithms, and the like. In at least some embodiments, the determination of the customer preferences may facilitate prediction of the propensity of the customer to initiate a purchase transaction having been displayed an advertisement.

In at least one example embodiment, the processor 202 is configured to, with the content of the memory 204, cause the system 200 to generate a revised estimate of the customer value by revising the initial estimate of the customer value based on at least one of the estimate of advertisement spend related to the customer and the propensity of the customer to perform the action in response to the advertisement displayed on the Website. In one embodiment, the action performed by the customer subsequent to viewing the advertisement on the Website may correspond to one of purchasing one or more products of the enterprise, availing a service offered by the enterprise, interacting with an agent over one or more interaction channels, and socializing at least one of a product, a purchase, a good sentiment, a bad sentiment, a brand, an experience, and a feeling.

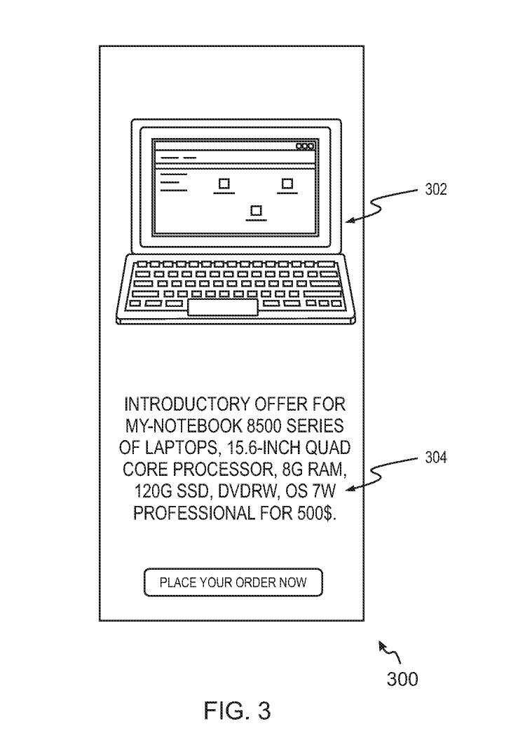

The generation of the revised estimate of customer value based on the propensity of the customer to perform the action in response to the advertisement displayed on the Website is further explained with reference to an illustrative example in FIG. 3.

Referring now to FIG. 3, an advertisement 300 displayed to a customer is shown in accordance with an embodiment of the invention. The advertisement 300 corresponds to an advertisement for a laptop computer. The advertisement 300 is depicted to include image content 302 (showing a laptop computer) and a text content 304 stating ‘Introductory offer for My-Notebook 8500 Series of Laptops, 15.6-Inch Quad Core Processor, 8G RAM, 120G SSD, DVDRW, OS 7 W Professional for 500$. Place your order now.’ The advertisement 300 may be displayed on the Website of the enterprise associated with the laptop or on a third-party website, such as a Website associated with an e-commerce entity, a retailer or a Web search engine service Website.

In an example embodiment, the processor 202, using information collated corresponding to the customer viewing the advertisement 300, may determine the initial estimate of customer value to be $1250. Further, based on past interaction history and current journey of the customer on the Website, the processor 202 may be configured to predict that there is 50% likelihood that the customer may purchase the laptop having viewed the advertisement 300. In such a scenario, the processor 202 may further be configured to revise the initial estimate of customer value to account for the potential impact of the advertisement on the customer value based on the current activity of the customer on the Website. In an illustrative example, the processor 202 may be configured to compute a value of $500*0.5=$250, i.e. the cost of the laptop multiplied by the probability of purchase, which is indicative of the potential impact of the advertisement to the customer value, and add the computed value to the initially computed customer value, i.e. $1250, to generate the corrected value of the customer value, i.e. $1500. In some embodiments, the probability of purchase may change with each subsequent advertisement that is displayed to the customer. For example, if the propensity of the customer to purchase a product is higher (for example, 60% or 0.6) when an advertisement is displayed to the customer second time, then such propensity of the customer may also be factored in to revise the initial estimate of the customer value. For example, a value of $500*0.6=$300, i.e. the cost of the laptop multiplied by the probability of purchase, may be computed and added to the initial estimate of customer value, i.e. $1250, to generate the corrected value of the customer value, i.e. $1550.

In one embodiment, revising the initial estimate of the customer value includes correcting the initial estimate of the customer value based on a cumulative effect of depreciation in the customer value caused by increasing advertising revenue spend and an appreciation in the customer value caused by potential impact of the advertisement displayed on the Website. For example, the revised estimate may be generated using equation:

Revised estimate of the customer value=Initial estimate of the customer value−f(ad-cost)+[P(purchase|Ad)−P(purchase|No Ad)]*(Average order value)
Wherein,
f(ad-cost) is the estimate of the advertisement spend related to the customer;
P(purchase|Ad) is probability of the customer engaging in a purchase transaction subsequent to the display of the advertisement, and
P(purchase|No Ad) is probability of the customer engaging in a purchase transaction if advertisement is not displayed on the Website.

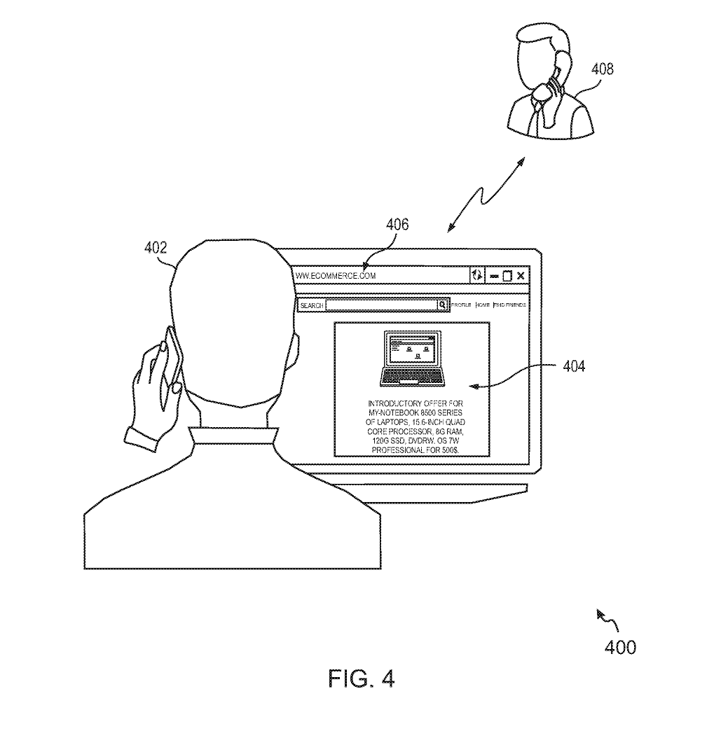

More specifically, as more money is spent on the customer, the net value of the customer changes over time; i.e. for every dollar spent, the customer value can be depreciated by $1 and appreciated with a potential impact of an advertisement on increased estimate of future customer purchase. The revision of the initial estimate of the customer value based on the cumulative effect of depreciation in the customer value caused by increasing advertising revenue spend and an appreciation in the customer value caused by potential impact of the advertisement displayed on the Website is explained later with reference to FIG. 4.

Referring now to FIG. 2, in at least one example embodiment, the apparatus 200 is caused to generate one or more recommendations corresponding to the customer based on the revised estimate of the customer value. The one or more recommendations are generated for achieving, at least in part, one or more predefined objectives of the enterprise. For example, if a predefined objective of an enterprise is a sales objective, i.e. to increase sales revenue, then the one or more recommendations may be generated with an intention of achieving such an objective. In an illustrative example, based on the revised estimate of the customer value, an example recommendation generated may be to offer a discount coupon to the customer as the revised estimate of the customer value (for example, a higher value) indicates that the customer is more likely to buy when offered a discount. In the absence of such advertisement spend based correction to the customer value, all customers with similar customer values may be treated in a generic manner, thereby reducing an impact of such a customer targeting strategy.

In another illustrative example, a predefined objective may be a service objective, i.e. to improve a customer's interaction experience. In an example scenario, a metric for evaluating an improvement in customer's interaction experience in a service scenario is a cumulative lifetime experience (CLE) value. The CLE value may be computed from several sentiments, emotions, or non-emotional interaction metrics (for example, average handle time (AHT), disconnection, voice referrals, etc.) associated with customer interactions on one or more channels, and from metrics for switching across interaction channels, as well as explicit feedback collected through customer surveys (for example, agent satisfaction surveys, net promoter score (NPS), etc.). Predictive models, such as machine learning models or statistical models, may be used in evaluating specific metrics for each interaction or the overall experience across several interactions. Accordingly, in a service scenario, for a customer who is currently active on an enterprise interaction channel, a recommendation to proactively offer chat assistance may be generated based on the corrected estimate of the customer value, which may indicate that the customer typically has a number of questions and would need assistance with the purchase.

In yet another illustrative example, a predefined objective may be an influence objective, i.e. to influence a potential customer into purchasing an enterprise offering. In an example scenario, where a product desired by the customer is out of stock then, based on the revised estimate of the customer value, a recommendation may be generated to offer other similar products to the customer because the collated information corresponding to the customer is indicative of the fact that the customer may be open to exploring other options if a particular product is out of stock.

Some other examples of recommendations generated based on the revised estimate of the customer value of a customer may include, but are not limited to, recommending up-sell/cross-sell products to the customer, suggesting products to up sell/cross-sell to an agent as a recommendation, offering a suggestion for a discount to the agent as a recommendation, recommending a style of conversation to the agent during an interaction, presenting a different set of productivity or visual widgets to agents with specific persona types on the agent interaction platform, presenting a different set of productivity or visual widgets to the customers with specific persona types on the customer interaction platform, suggesting proactive interaction, customizing the speed of interaction, customizing the speed of servicing information, and the like.

In an example embodiment, based on the revised estimate of the customer value for the customer, a recommendation suggesting routing the customer's interaction to the queue with the least waiting time or to the most suitable agent based on an agent persona type or a skill level associated with the agent may also be generated by the apparatus 200.

In at least one example embodiment, the processor 202 is configured to, with the content of the memory 204, cause the apparatus 200 to facilitate engagement with the customer on the Website. In one embodiment, a type of engagement with the customer is determined based on the revised estimate of the customer value. For example, the apparatus 200 may be caused to provide the one or more recommendations to an agent of the enterprise to facilitate engagement with the customer on the Website. In some embodiments, the apparatus 200 may also be caused to facilitate a provisioning, for example by using agents or directly through device APIs, of at least one of a personalized treatment and a preferential treatment to the customer based on the one or more recommendations. Some non-limiting examples of personalized treatment provisioned to the customer may include sending a self serve link to the customer, sharing a knowledge base article, providing resolution to a customer query over an appropriate interaction channel, escalating or suggesting escalation of customer service level, offering a discount to the customer, recommending products to the customer for up-sell/cross-sell, proactively offering interaction, customizing the speed of interaction, customizing the speed of servicing information, deflecting interaction to a different interaction channel historically preferred by the customer, and the like. Some non-limiting examples of preferential treatment provisioned to the customer may include providing immediate agent assistance, routing an interaction to an agent with the best matching persona type, routing the interaction to a queue with the least waiting time, etc.

In at least some embodiments, the engagement in form of personalized treatment and/or the preferential treatment may be provisioned to the customer based on interaction data associated with past interactions of the customer with the enterprise on one or more interaction channels. For example, if the customer has historically preferred voice call interaction, then the current Web interaction may be deflected to a voice call interaction to provide a personalized interaction experience to the customer. In another illustrative example, if the customer has historically abandoned an interaction when the customer has been made to wait to speak to an agent, then the customer may be provisioned preferential treatment, for example, in form of immediate agent assistance or by routing the interaction to a queue with the least waiting time.

FIG. 4 shows a representation 400 for illustrating assessment of customer value based on customer interactions with advertisements in accordance with an embodiment of the invention. More specifically, the representation 400 depicts a customer 402 viewing an advertisement 404 displayed on a Website 406 related to an enterprise. As explained with reference to FIG. 2, for a customer currently active on a Website, information related to the current Web journey may be tracked using HTML or JavaScript tags on components, such as images, textual contents, hyperlinks, etc. displayed on the Website. Such tracked information may be received by the communication interface 208 of the apparatus 200 (shown in FIG. 2). In some embodiments, the apparatus 200 may be caused to identify the customer 402 (for example, using login information, IP address, customer input, etc.).

The apparatus 200 may further be caused to determine an initial estimate of customer value for the customer 402. The initial estimate of customer value may be determined based on past interaction data and using modeling approaches, such as RFM, Markov modeling, etc. If the customer 402 is a first-time visitor to the Website (or in general an un-identified customer), the system 200 may be caused to identify a customer segment relevant to the customer 402 and use a customer value associated with a segment as the initial estimate of the customer value for the customer 402. Further, an estimate of advertisement spend based on historic customer interactions with advertisements may be determined. If the customer 402 is a first-time visitor to the Website (or in general an un-identified customer), the advertisement spend may correspond to cost of displaying ads during the current journey on the Website 406. Furthermore, a propensity of the customer 402 to perform an action, such as for example a purchase transaction, in response to display of an advertisement, such as the advertisement 404 may be determined. The initial estimate of the customer value for the customer 402 may then be revised based on the estimate of the advertisement spend and the propensity of the customer to perform an action in response to display of an advertisement. As explained in FIG. 2, the revised estimate may be computed using:

Revised estimate of the customer value=Initial estimate of the customer value−f(ad-cost)+[P(purchase|Ad)−P(purchase|No Ad)]*(Average order value)

As an example, if the initial estimate of customer value for the customer 402 is $1000 and the estimate of advertisement spend (referred to herein as ad-cost) since last purchase is $100 and customer 402 is looking at the advertisement 404 showing a $500 product with 50% chance of purchasing, then the revised estimate of customer value may be computed as shown in (1):

CUSTOMER VALUE=$1000−$100+($500*0.5)=$1150 (1)

Further as explained with reference to FIG. 2, the system 200 may be caused to correct the estimate of the customer value based on a cumulative effect of depreciation in the customer value caused by increasing advertising revenue spend and an appreciation in the customer value caused by potential impact of the advertisement displayed on the Website. So, if the customer 402 clicks on the advertisement 404 and does not purchase the enterprise offering and is offered another advertisement, thereby increasing advertisement spending by $10 while increasing the probability associated with purchase propensity to 60% (for example, the customer 402 would have higher propensity to purchase on second ad click), then the revised estimate of customer value may be computed as shown in (2):

CUSTOMER VALUE=$1000+($500*0.6)−$110=$1190 (2)

As can be seen, such assessment of customer value based on customer interaction with advertisements takes into account the cost of marketing, i.e. displaying advertisements, to the customer and also takes into consideration the propensity of the customer to take an action if shown a particular ad. As a result, the estimated customer value is more realistic reflection of the worth of the customer to the enterprise. The enterprise may then choose an appropriate targeting strategy for the customer. In the representation 400, the apparatus 200 is depicted to have facilitated an engagement of the customer 402 in form of a voice-based interaction with a human agent 408 associated with the enterprise. More specifically, the apparatus 200 may be caused to generate one or more recommendations based on the revised estimate of customer value for the customer 402. For instance, a recommendation to push a widget offering assistance in form of a voice-based interaction with an agent may be generated by the apparatus 200 to achieve a sales objective. Accordingly, if the customer 402 clicks on the advertisement 404, then a widget (not shown in the representation 400) may be displayed to the customer 402 on the Website 406. A customer selection of the widget in form of a touch input or a click input may cause routing of a request for voice-based assistance to an appropriate human agent, such as the agent 408, associated with the enterprise. The agent 408 may assist the customer 402 with queries that the customer 402 may have and in general help the customer 402 to perform a purchase transaction during the current journey on the Website 406.

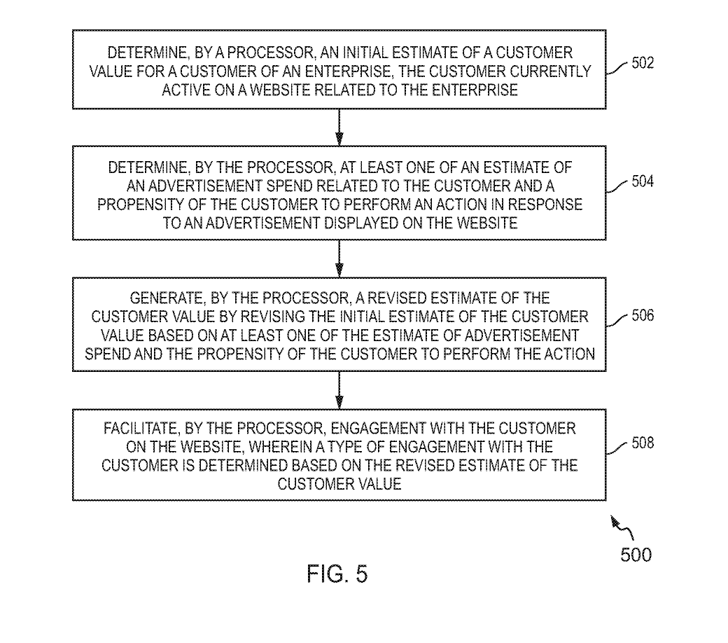

A method for assessing customer value based on customer interactions with advertisements is explained with reference to FIG. 5.

FIG. 5 is a flow diagram of an example method 500 for assessing customer value of a customer based on customer interactions with advertisements in accordance with an embodiment of the invention. The method 500 depicted in the flow diagram may be executed by, for example, the apparatus 200 explained with reference to FIGS. 2 to 4. Operations of the flowchart, and combinations of operation in the flowchart, may be implemented by, for example, hardware, firmware, a processor, circuitry, and/or a different device associated with the execution of software that includes one or more computer program instructions. The operations of the method 500 are described herein with help of the apparatus 200. For example, one or more operations corresponding to the method 500 may be executed by a processor, such as the processor 202 of the apparatus 200. Although the one or more operations are explained herein to be executed by the processor alone, the processor is associated with a memory, such as the memory 204 of the apparatus 200, which is configured to store machine executable instructions for facilitating the execution of the one or more operations. The operations of the method 500 can be described and/or practiced by using a system, other than the apparatus 200. The method 500 starts at operation 502.

At operation 502 of the method 500, an initial estimate of a customer value for a customer currently active on a Website related to the enterprise is determined by a processor, such as the processor 202 of the apparatus 200 explained with reference to FIG. 2. The term ‘customer value’ as used herein refers to a value a business derives from their relationship with a customer over a predefined period of time, such as for example a lifetime of the customer. In one embodiment, the initial estimate of the customer value is determined using interaction data associated with past interactions of the customer with the enterprise on one or more interaction channels. The interaction data may include data related to customer activity on a Website related to the enterprise, voice or chat conversations with enterprise agents, and the like.

In one embodiment, a customer lifetime value (CLV) estimate may be computed for the customer using the interaction data. The computed CLV estimate may serve as the initial estimate of the customer value for the customer. The CLV estimate may be computed using recency-frequency-monetary value (RFM) approach, which models the customer value as a function of how recently the customer interacted with the enterprise, a frequency of customer interactions, and monetary values of customer transactions associated with the customer interactions. The customer value may also be estimated in other forms and may not be limited to a CLV estimate. For example, the CLV estimate may be determined using any one of several models, such as those based on stochastic modeling, Markov models, Markov decision process (MDP), policy iteration algorithms for infinite horizon problems, value iteration algorithms for finite horizon problems, survival models, retention or churn models, and the like, and may not be limited to the RFM approach. Such approaches model CLV as a function of recency, frequency, monetary value, discount rate, churn/retention rate, acquisition rate, retention costs, acquisition costs, revenue, advertising or campaign cost, cost of serving the customers, state transition probability matrix, and the like.

In some embodiments, the customer may be a first-time visitor to an enterprise Website and may not have sufficient interaction data to facilitate determination of the initial estimate of customer value using modeling approaches suggested above. In such a scenario, the processor may identify a customer segment relevant to the customer from among a plurality of customer segments. For example, based on the geographical location, type of browser/operating system associated with the customer, information from current Web journey, i.e. products viewed, selected etc., a customer segment may be identified for the customer. Each customer segment may be associated with a customer value. More specifically, the processor may be configured to classify customers in different segments based on customer values and associate traits or characteristics with each segment. For example, customers in a customer segment may have exhibited a particular Web journey, or used a particular browser or operating system, or belong to a particular geographical location, and the like. For a first-time visitor to an enterprise channel, a customer segment relevant to the customer may be identified from among a plurality of customer segments and the customer value associated with the customer segment may be selected as the initial estimate of the customer value for the customer.

At operation 504 of the method 500, at least one of an estimate of an advertisement spend related to the customer and a propensity of the customer to perform an action in response to an advertisement displayed on the Website is determined by the processor. In an embodiment, the processor may be configured to receive data related to each customer's interaction with digital advertisements of the enterprise displayed to the customer during several past journeys of the customer on the Website, as well as the current journey of the customer on the Website. For example, if a customer was presented an advertisement (associated with ‘x’ cost) during a journey, then the information corresponding to the advertisement presented such as, for example, product information displayed by the advertisement, image content presented, etc., along with cost related to presenting the advertisement to the customer may be received by the processor. In one embodiment, the estimate of the advertisement spend is determined by computing an aggregate cost of advertisements displayed to the customer over a predefined time period such as, for example, ad cost in last 24 hours, in last 7 days, in last 30 days, etc.

In an illustrative example, the processor may be configured to track measures, such as the aggregate cost of advertisements displayed to the customer since a last purchase, a number of times a particular advertisement was displayed to the customer, the propensity of the customer to make a purchase when shown the same advertisement (or substantially similar advertisement) multiple number of times, a position of the advertisement of the UI on the Web page, and the like.

At operation 506 of the method 500, a revised estimate of the customer value is generated by the processor by revising the initial estimate of the customer value based on at least one of the estimate of advertisement spend related to the customer and the propensity of the customer to perform the action in response to the advertisement displayed on the Website. In one embodiment, the processor is configured to discount the initial estimate of customer value by an amount equivalent to the estimate of advertisement spend related to the customer. In some embodiments, a propensity of the customer to initiate a purchase transaction having been displayed a particular advertisement may also be taken into account while correcting the customer value. In some embodiments, the processor may be configured to determine customer preferences from predictive models based on historical interaction data as explained with reference to FIG. 2. In at least some embodiments, the determination of the customer preferences may facilitate prediction of the propensity of the customer to initiate a purchase transaction having been displayed an advertisement.

In one embodiment, the action performed by the customer subsequent to viewing the advertisement on the Website may correspond to one of purchasing one or more products of the enterprise, availing a service offered by the enterprise, interacting with an agent over one or more interaction channels, and socializing at least one of a product, a purchase, a good sentiment, a bad sentiment, a brand, an experience, and a feeling.

In one embodiment, revising the initial estimate of the customer value includes correcting the initial estimate of the customer value based on a cumulative effect of depreciation in the customer value caused by increasing advertising revenue spend and an appreciation in the customer value caused by potential impact of the advertisement displayed on the Website. For example, the revised estimate may be generated using equation:

Revised estimate of the customer value=Initial estimate of the customer value−f(ad-cost)+[P(purchase|Ad)−P(purchase|No Ad)]*(Average order value)
Wherein,
f(ad-cost) is the estimate of the advertisement spend related to the customer;
P(purchase|Ad) is probability of the customer engaging in a purchase transaction subsequent to the display of the advertisement; and
P(purchase|No Ad) is probability of the customer engaging in a purchase transaction if advertisement is not displayed on the Website.

More specifically, as more money is spent on the customer the next value of the customer changes over time; i.e. for every dollar spent, the customer value can be depreciated by $1.00 and appreciated with a potential impact of an advertisement on increased estimate of future customer purchase.

In at least one example embodiment, the processor is caused to generate one or more recommendations corresponding to the customer based on the revised estimate of the customer value. The one or more recommendations are generated for achieving, at least in part, one or more predefined objectives of the enterprise. For example, if a predefined objective of an enterprise is a sales objective, i.e. to increase sales revenue, then the one or more recommendations may be generated with an intention of achieving such an objective. In another illustrative example, a predefined objective may be a service objective, i.e. to improve a customer's interaction experience. In yet another illustrative example, a predefined objective may be an influence objective, i.e. to influence a potential customer into purchasing an enterprise offering. The generation of recommendations may be performed as explained with reference to FIG. 2.

At operation 508 of the method 500, engagement with the customer on the Website is facilitated. In one embodiment, a type of engagement with the customer is determined based on the revised estimate of the customer value. For example, the processor may be caused to provide the one or more recommendations to an agent of the enterprise to facilitate engagement with the customer on the Website. In some embodiments, the processor may also be caused to facilitate a provisioning, for example by using agents or directly through device APIs, of at least one of a personalized treatment and a preferential treatment to the customer based on the one or more recommendations. The provisioning of personalized and/or preferential treatment may be performed as explained with reference to FIG. 2 and is not explained again herein. The method 500 ends at operation 508.

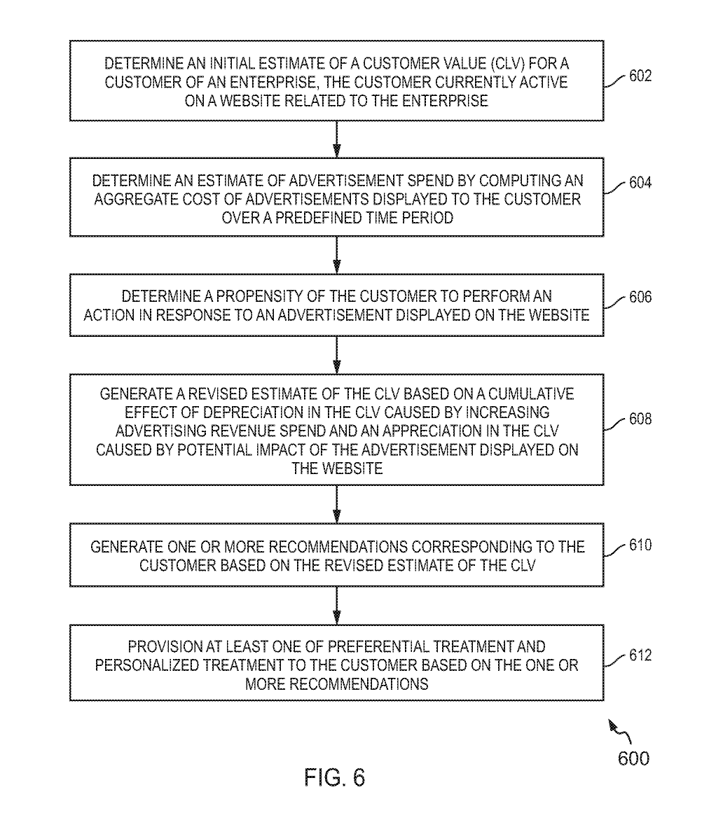

FIG. 6 is a flow diagram of an example method 600 for assessing customer value of a customer based on customer interactions with advertisements in accordance with another embodiment of the invention. The method 600 depicted in the flow diagram may be executed by, for example, the apparatus 200 explained with reference to FIGS. 2 to 4. Operations of the flowchart, and combinations of operation in the flowchart, may be implemented by, for example, hardware, firmware, a processor, circuitry, and/or a different device associated with the execution of software that includes one or more computer program instructions. The method 600 starts at operation 602.

At operation 602 of the method 600, an initial estimate of a customer lifetime value (CLU) for a customer currently active on a Website related to the enterprise is determined. The initial estimate of the customer lifetime value may be determined using interaction data as explained with reference to FIG. 2.

At operation 604 of the method 600, an estimate of advertisement spend is determined by computing an aggregate cost of advertisements displayed to the customer over a predefined time period.

At operation 606 of the method 600, a propensity of the customer to perform an action in response to an advertisement displayed on the Website may be determined. The determination of the propensity of the customer to perform an action may be determined as explained with reference to operation 504 of the method 500.

At operation 608 of the method 600, a revised estimate of the CLV based on a cumulative effect of depreciation in the CLV caused by increasing advertising revenue spend and an appreciation in the CLV caused by potential impact of the advertisement displayed on the Website is generated. In one embodiment, the advertising revenue spend is computed based on the estimate of the advertisement spend and a cost associated with the advertisement. In one embodiment, the potential impact of the advertisement is determined based on the propensity of the customer to perform an action in response to the advertisement.

At operation 610 of the method 600, one or more recommendations corresponding to the customer are generated based on the revised estimate of the CLV. At operation 612 of the method 600, at least one of preferential treatment and personalized treatment to the customer based on the one or more recommendations is provisioned. The method 600 ends at operation 612.

Various embodiments disclosed herein provide numerous advantages. The techniques disclosed herein enable enterprises to determine customer values more accurately. More specifically, a value of a customer relationship is determined in an accurate manner by taking into account a cost component associated with marketing spend on the customer as well as the propensity of the customer to perform an action, such as initiate a purchase transaction during an ongoing interaction. Such computation of customer values enables the enterprises to better segment customers into suitable categories in order to treat each customer differentially based on the customer value. For example, the enterprises may determine most valuable customers based on customer value and provide suitable recommendation or discounts, or route their interactions to best-matched agents instead of providing such treatment to less valuable customers. This substantially improves efficiency with regard to use of compute and network resources within an enterprise, for example.

Although the invention has been described with reference to specific exemplary embodiments, various modifications and changes may be made to these embodiments without departing from the broad spirit and scope of the invention. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the apparatus 200, the processor 202, the memory 204, the I/O module 206 and the communication interface 208 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIGS. 5 and 6). A computer-readable medium storing, embodying, or encoded with a computer program, or similar language, may be embodied as a tangible data storage device storing one or more software programs that are configured to cause a processor or a computer to perform one or more operations. Such operations may be, for example, any of the steps or operations described herein.

In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories such as mask ROM, PROM (programmable ROM), EPROM (erasable PROM), flash memory, RAM (random access memory), etc. Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line, e.g. electric wires, and optical fibers, or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the invention.

1. A computer-implemented method, comprising:
determining, by a processor, an initial estimate of a customer value for a customer of an enterprise, the customer currently active on a Website related to the enterprise;
determining, by the processor, at least one of an estimate of an advertisement spend related to the customer and a propensity of the customer to perform an action in response to an advertisement displayed on the Website;
generating, by the processor, a revised estimate of the customer value by revising the initial estimate of the customer value based on at least one of the estimate of advertisement spend related to the customer and the propensity of the customer to perform the action in response to the advertisement displayed on the Website; and
facilitating, by the processor, engagement with the customer on the Website, wherein a type of engagement with the customer is determined based on the revised estimate of the customer value.

2. The method of claim 1, further comprising:
determining, by the processor, the initial estimate of the customer value by using interaction data associated with past interactions of the customer with the enterprise on one or more interaction channels.

3. The method of claim 2, further comprising;
determining, by the processor, the initial estimate of the customer value from a customer lifetime value (CLV) estimate for the customer, said CLV determined from the interaction data, wherein the computed CLV estimate comprises the initial estimate of the customer value for the customer.

4. The method of claim 3, further comprising:
determining, by the processor, the CLV estimate based on at least one of a recency of interactions of the customer with the enterprise, a frequency of the interactions of the customer with the enterprise, and monetary values of transactions associated with the interactions of the customer with the enterprise.

5. The method of claim 1, further comprising:
identifying, by the processor, a customer segment from among a plurality of customer segments that is relevant to the customer, wherein each customer segment is associated with a customer lifetime value (CLV);
determining, by the processor, the initial estimate of the customer value for the customer based on the CLV associated with the customer segment identified to be relevant to the customer.

6. The method of claim 1, further comprising:
determining, by the processor, the estimate of the advertisement spend by computing an aggregate cost of advertisements displayed to the customer over a predefined time period.

7. The method of claim 1, further comprising:
revising, by the processor, the initial estimate of the customer value by correcting the initial estimate of the customer value based on a cumulative effect of depreciation in the customer value, wherein said cumulative effect of depreciation in the customer value is based on both increasing advertising revenue spend and an appreciation in the customer value caused by potential impact of the advertisement displayed on the Website.

8. The method of claim 1, further comprising;
generating, by the processor, the revised estimate based upon application of the equation:
Revised estimate of the customer value=Initial estimate of the customer value−f(ad-cost)+[P(purchase|Ad)−P(purchase|No Ad)]*(Average order value)
Wherein,
f(ad-cost) is an estimate of advertisement spend related to the customer;
P(purchase|Ad) is probability of the customer engaging in a purchase transaction subsequent to display of the advertisement; and
P(purchase|No Ad) is probability of the customer engaging in a purchase transaction if an advertisement is not displayed on the Website.

9. The method of claim 1, wherein the action comprises any of purchasing one or more products of the enterprise, availing a service offered by the enterprise, interacting with an agent over one or more interaction channels, and socializing at least one of a product, a purchase, a good sentiment, a bad sentiment, a brand, an experience, and a feeling.

10. The method of claim 1, further comprising:
generating, by the processor, one or more recommendations corresponding to the customer based on the revised estimate of the customer value, to achieve one or more predefined objectives of the enterprise.

11. The method of claim 10, wherein a predefined objective from among the one or more predefined objectives comprises any of a sales objective and a service objective, and wherein the sales objective is indicative of a goal of increasing sales revenue of the enterprise and the service objective is indicative of a motive of improving interaction experience of the customer.

12. The method of claim 10, further comprising:
providing the one or more recommendations, by the processor, to an agent of the enterprise to facilitate engagement with the customer on the Website.

13. An apparatus, comprising:
at least one processor; and
a memory having stored therein machine executable instructions, that when executed by the at least one processor, cause the apparatus to:
determine an initial estimate of a customer value for a customer of an enterprise, the customer currently active on a Website related to the enterprise;
determine at least one of an estimate of an advertisement spend related to the customer and a propensity of the customer to perform an action in response to an advertisement displayed on the Website;
generate a revised estimate of the customer value by revising the initial estimate of the customer value based on at least one of the estimate of advertisement spend related to the customer and the propensity of the customer to perform the action in response to the advertisement displayed on the Website; and
facilitate engagement with the customer on the Website, wherein a type of engagement with the customer is determined based on the revised estimate of the customer value.

14. The apparatus of claim 13, wherein the apparatus is further caused to:
compute a customer lifetime value (CLV) estimate for the customer using interaction data associated with past interactions of the customer with the enterprise on one or more interaction channels, wherein the computed CLV estimate comprises the initial estimate of the customer value for the customer, wherein the CLV estimate is computed based on at least one of a recency of interactions of the customer with the enterprise, a frequency of the interactions of the customer with the enterprise, and monetary values of transactions associated with the interactions of the customer with the enterprise.

15. The apparatus of claim 13, wherein the apparatus is further caused to:
determine the estimate of the advertisement spend by computing an aggregate cost of advertisements displayed to the customer over a predefined time period.

16. The apparatus of claim 13, wherein the apparatus is further caused to:
generate the revised estimate using the equation:
Revised estimate of the customer value=Initial estimate of the customer value−f(ad-cost)+[P(purchase|Ad)−P(purchase|No Ad)]*(Average order value)
Wherein,
f(ad-cost) is an estimate of advertisement spend related to the customer;
P(purchase|Ad) is probability of the customer engaging in a purchase transaction subsequent to display of the advertisement; and
P(purchase|No Ad) is probability of the customer engaging in a purchase transaction if an advertisement is not displayed on the Website.

17. The apparatus of claim 13, wherein the apparatus is further caused to:
generate one or more recommendations corresponding to the customer based on the revised estimate of the customer value, to achieve one or more predefined objectives of the enterprise; and
provide the one or more recommendations to an agent of the enterprise to facilitate engagement with the customer on the Website.

18. A computer-implemented method, comprising:
determining, by a processor, an initial estimate of a customer lifetime value (CLV) for a customer of an enterprise for a customer who is currently active on a Website related to the enterprise;
determining, by the processor, an estimate of advertisement spend by computing an aggregate cost of advertisements displayed to the customer over a predefined time period;
determining, by the processor, a propensity of the customer to perform an action in response to an advertisement displayed on the Website;
generating, by the processor, a revised estimate of the CLV based on a cumulative effect of depreciation in the CLV caused by increasing advertising revenue spend and an appreciation in the CLV caused by potential impact of the advertisement displayed on the Website;
computing, by the processor, the advertising revenue spend based on the estimate of the advertisement spend and a cost associated with the advertisement;
determining, by the processor, the potential impact of the advertisement based on the propensity of the customer to perform an action in response to the advertisement;
generating, by the processor, one or more recommendations corresponding to the customer based on the revised estimate of the CLV; and
provisioning, by the processor, at least one of preferential treatment and personalized treatment to the customer based on the one or more recommendations.

19. The method of claim 18, wherein the revised estimate is generated, by the processor, using the equation:
Revised estimate of the customer value=Initial estimate of the customer value−f(ad-cost)+[P(purchase|Ad)−P(purchase|No Ad)]*(Average order value)
Wherein,
f(ad-cost) is an estimate of the advertisement spend related to the customer;
P(purchase|Ad) is probability of the customer engaging in a purchase transaction subsequent to display of the advertisement; and
P(purchase|No Ad) is probability of the customer engaging in a purchase transaction if an advertisement is not displayed on the Website

20. The method of claim 18, further comprising:
providing the one or more recommendations, by the processor, to an agent of the enterprise to facilitate engagement with the customer on the Website for provisioning of at least one of the preferential treatment and personalized treatment to the customer.
